(19) United States
(12) Patent Application Publication
(10) Pub. No.: US 2010/0016157 A1
(43) Pub. Date: Jan. 21, 2010

(54) SYNERGISTIC SEED TREATMENT COMPOSITIONS

(75) Inventor: Birgit Forster, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/568,033

(22) Filed: Sep. 28, 2009

Related U.S. Application Data
(63) Continuation of application No. 10/496,187, filed on Oct. 14, 2004, now abandoned.

(30) Foreign Application Priority Data
Nov. 27, 2001 (GB) 0128390.2

(51) Int. Cl. A01N 25/26; A01N 43/36; A01N 43/54; A01N 43/40

(52) U.S. Cl. 504/100; 504/138; 504/136; 504/130

(57) ABSTRACT

An agrochemical composition for the treatment of plant propagation material, comprising at least two active ingredient components together with a suitable carrier, wherein component I is fludioxonil (=4-(2,2-difluoro-1,3-benzodioxol-4-yl)pyrrole-3-carbonitrile) and wherein component II is azoxystrobin (=methyl (E)-2-{2-[6-(2-cyanophenoxy)pyrimidin-4-yloxy]phenyl}-3-methoxyacrylate) or picoxystrobin (=methyl (E)-3-methoxy-2-[2-(6-trifluoromethyl-2-pyridyloxymethyl)phenyl]acrylate) or kresoxim-methyl (=methyl (E)-methoxyimino[2-(o-tolyloxymethyl)phenyl]acetate.

This application is a continuation of U.S. application Ser. No. 10/496,187 filed Oct. 14, 2004, which is a National Stage Entry under 35 U.S.C. §371 of PCT/IB02/05241filed Nov. 25, 2002, which claims priority to GB 0128390.2, filed on Nov. 27, 2001, the contents of which are incorporated herein by reference.

The present invention relates to fungicidal mixtures for the treatment of plant propagation material and to methods of using such mixtures in crop protection.

The mixtures according to the invention comprise at least two fungicidally active components together with a suitable carrier material, wherein component I is
I) fludioxonil (=4-(2,2-difluoro-1,3-benzodioxol-4-yl)pyrrole-3-carbonitrile; The Pesticide Manual, 12th. edition, 2000, 361);
   and wherein component II is
IIA) azoxystrobin (=methyl (E)-2-{2-[6-(2-cyanophenoxy)pyrimidin-4-yloxy]phenyl}-3-methoxyacrylate; The Pesticide Manual, 12th. edition, 2000, 49) or
IIB) picoxystrobin (=methyl (E)-3-methoxy-2-[2-(6-trifluoromethyl-2-pyridyloxymethyl)phenyl]acrylate; The Pesticide Manual, 12th. edition, 2000, 622) or
IIC) kresoxim-methyl (=methyl (E)-methoxyimino[2-(o-tolyloxymethyl)phenyl]acetate; The Pesticide Manual, 12th. edition, 2000, 472).

The fungicidal mixtures according to the invention have very advantageous properties for protecting plants against disease infestation, particularly in the control and prevention of disease infestation on seed and soil.

These properties are for example the synergistically enhanced action of mixtures of components I and II, resulting in lower disease infestation, lower rates of application, a longer duration of action and altogether higher crop yields. Another property improved by the instant mixtures is summarized as plant vigor. Under the term plant vigor there are understood various sorts of improvements of plants which are not connected to the control of pests. For example such advantageous properties that may be mentioned are improved crop characteristics including: emergence, crop yields, protein content, more developed root system, tillering increase, increase in plant height, bigger leaf blade, less dead basal leaves, stronger tillers, greener leaf color, less fertilizer needed, less seeds needed, more productive tillers, earlier flowering, early grain maturity, less plant verse (lodging), increased shoot growth, increased plant stand and early germination; or any other advantages familiar to a person skilled in the art. Such enhancements were not to be expected from the activity of the individual components.

The weight ratio is selected as to give the desired, for example synergistic, action. In general, the weight ratio I:II is from 5:1 to 1:30, preferably from 2.5:1 to 1:15. Advantageous mixing ratios of the two active ingredients are 2.5:1, 1.25:1 and 1:6 by weight.

The above mentioned mixtures may be mixed with other pesticides, preferably fungicides, resulting in some cases in unexpected synergistic activities.

The active ingredient mixtures in question can be used as dressings in the treatment of plant propagation material, especially seed (fruit, tubers, grains) and plant cuttings (e.g. rice), to provide protection against fungus infections on the seed as well as against phytopathogenic fungi which occur in the soil. The active ingredient mixtures according to the invention are distinguished by the fact that they are especially well tolerated by plants and are environmentally friendly.

The active ingredient mixtures are effective against phytopathogenic fungi belonging to the following classes: Ascomycetes (e.g. Penicillium, Gaeumannomyces graminis); Basidiomycetes (e.g. the genus Hemileia, Rhizoctonia, Puccinia); Fungi imperfecti (e.g. Botrytis, Helminthosporium, Rhynchosporium, Fusarium, Septoria, Cercospora, Alternaria, Pyricularia and Pseudocercosporella herpotrichoides); Oomycetes (e.g. Phytophthora, Peronospora, Bremia, Pythium, Plasmopara).

Target crops for the areas of indication disclosed herein comprise within the scope of this invention e.g. the following species of plants: cereals (wheat, barley, rye, oats, corn, maize, rice, sorghum and related crops); beet (sugar beet and fodder beet); leguminous plants (beans, lentils, peas, soybeans); oil plants (rape, mustard, sunflowers,); cucumber plants (marrows, cucumbers, melons); fibre plants (cotton, flax, hemp, jute); vegetables (spinach, lettuce, asparagus, cabbages, carrots, onions, tomatoes, potatoes, paprika); as well as ornamentals (flowers, shrubs, broad-leaved trees and evergreens, such as conifers). This list does not represent any limitation.

The active ingredient mixtures according to the invention are especially advantageous for the treatment of plant propagation material, especially seeds, of cotton, corn, soybeans, rice and peanuts.

The mixtures of compounds I and II are normally used in the form of compositions. The compounds I and 11 can be applied to the plant propagation material to be treated either simultaneously or in succession at short interval, for example on the same day, if desired together with further carriers, surfactants or other application-promoting adjuvants customarily employed in formulation technology.

Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

In order to treat plant propagation material, especially seed, the compounds I and II can also be applied to the seeds (coating), either by impregnating the tubers or grains with a liquid formulation of each of the active ingredients in succession, or by coating them with an already combined wet or dry formulation.

The compounds of the combination are used in unmodified form or, preferably, together with the adjuvants conventionally employed in formulation technology, and are therefore formulated in known manner e.g. into emulsifiable concentrates, coatable pastes, directly sprayable or dilutable solutions, dilute emulsions, wettable powders, soluble powders, dusts, granules, or by encapsulation in e.g. polymer substances. As with the nature of the compositions, the methods of application, such as spraying, atomizing, dusting, scattering, coating or pouring, are chosen in accordance with the intended objectives and the prevailing circumstances. Advantageous rates of application of the active ingredient mixture are generally from 2 g to 35 g, preferably from 2 g to 20 g, per 100 kg of plant propagation material, especially seed. Preferred rates are from 1 g to 5 g, especially preferred 2.5 g, of compound I and 1 g to 30 g, especially preferred 1 g to 15 g, of compound II per 100 kg of plant propagation material, especially seed.

The formulations are prepared in known manner, e.g. by homogeneously mixing and/or grinding the active ingredients with extenders, e.g. solvents, solid carriers and, where appropriate, surface-active compounds (surfactants).

Suitable solvents are: aromatic hydrocarbons, preferably the fractions containing 8 to 12 carbon atoms, e.g. xylene mixtures or substituted naphthalenes, phthalates, such as dibutyl phthalate or dioctyl phthalate, aliphatic hydrocarbons, such as cyclohexane or paraffins, alcohols and glycols and their ethers and esters, such as ethanol, ethylene glycol, ethylene glycol monomethyl or monoethyl ether, ketones, such as cyclohexanone, strongly polar solvents, such as N-methyl-2-pyrrolidone, dimethyl sulfoxide or dimethylformamide, as well as vegetable oils or epoxidised vegetable oils, such as epoxidised coconut oil or soybean oil; or water.

The solid carriers used, e.g. for dusts and dispersible powders, are normally natural mineral fillers, such as calcite, talcum, kaolin, montmorillonite or attapulgite. In order to improve the physical properties it is also possible to add highly dispersed silicic acid or highly dispersed absorbent polymers. Suitable granulated adsorptive carriers are porous types, for example pumice, broken brick, sepiolite or bentonite, and suitable nonsorbent carriers are, for example, calcite or sand. In addition, a great number of pregranulated materials of inorganic or organic nature can be used, e.g. especially dolomite or pulverized plant residues.

Depending upon the nature of the compounds I and II to be formulated, suitable surface-active compounds are non-ionic, cationic and/or anionic surfactants having good emulsifying, dispersing and wetting properties. The term “surfactants” will also be understood as comprising mixtures of surfactants.

Particularly advantageous application-promoting adjuvants are also natural or synthetic phospholipids of the cephalin and lecithin series, e.g. phosphatidylethanolamine, phosphatidylserine, phosphatidylglycerol and lysolecithin.

The agrochemical compositions normally comprise 0.1 to 99%, especially 0.1 to 95%, compounds I and II, 99.9 to 1%, especially 99.9 to 5%, of a solid or liquid adjuvant and 0 to 25%, especially 0.1 to 25%, of a surfactant.

Whereas commercial products will preferably be formulated as concentrates, the end user will normally employ dilute formulations.

The Examples which follow serve to illustrate the invention, “active ingredient” denoting a mixture of compound I and compound II in a specific mixing ratio.

### FORMULATION EXAMPLES

| Wettable powders | a) | b) | c) |
|---|---|---|---|
| active ingredient [I:II = 1:6(a), 1:2(b), 1:1(c)] | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The active ingredient is thoroughly mixed with the adjuvants and the mixture is thoroughly ground in a suitable mill, affording wettable powders which can be diluted with water to give suspensions of the desired concentration.

| Dusts | a) | b) | c) |
|---|---|---|---|
| active ingredient [I:II = 1:6(a), 1:2(b), 1:10(c)] | 5% | 6% | 4% |
| Talcum | 95% | — | — |
| Kaolin | — | 94% | — |
| mineral filler | — | — | 96% |

Ready-for-use dusts are obtained by mixing the active ingredient with the carrier and grinding the mixture in a suitable mill. Such powders can be used for dry dressings for seed.

Suspension Concentrate

| | |
|---|---|
| active ingredient (I:II = 1:8) | 40% |
| propylene glycol | 10% |
| nonylphenol polyethylene glycol ether | 6% |
| (15 mol of ethylene oxide) | |
| sodium lignosulfonate | 10% |
| carboxymethylcellulose | 1% |
| silicone oil (in the form of a 75% emulsion in water) | 1% |
| water | 32% |

The finely ground active ingredient is intimately mixed with the adjuvants, giving a suspension concentrate from which suspensions of any desired dilution can be obtained by dilution with water. Using such dilutions plant propagation material can be treated and protected against infestation by microorganisms, by spraying, pouring or immersion.

### Biological Examples

A synergistic effect exists, for example, whenever the action of an active ingredient combination is greater than the sum of the actions of the individual components.

The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):
ppm=milligrams of active ingredient (=a.i.) per litre of spray mixture
X=% action by active ingredient I using p ppm of active ingredient
Y=% action by active ingredient II using q ppm of active ingredient.

According to Colby, the expected (additive) action of active ingredients I+II using p+q ppm of active ingredient is

$$E = X + Y - \frac{X \cdot Y}{100}$$

If the action actually observed (O) is greater than the expected action (E), then the action of the combination is superadditive, i.e. there is a synergistic effect.

A1) Rhizoctonia solani/Cotton (Damping Off on Cotton)

A defined amount of mycelium of R. solani is blended with soil and trays are filled with the inoculated soil. The formulated test mixtures are applied to cotton seeds (cv. Sure Grow 747). The treated cotton seeds are then sown into the inoculated soil. Until germination the trays are stored at 20° C. and a rel. humidity of 90% in the dark. After germination the trays are transferred to 25° C. and a rel. humidity of 70% with a photoperiod of 14 h. The evaluation is done by counting the emerged cotton plants and the number of emerged and diseased plants.

The mixtures I+IIA, I+IIB and I+IIC according to the instant invention show good synergistic action.

1. An agrochemical composition for the treatment of plant propagation material, comprising a synergistically effective amount of a mixture of consisting essentially of components I and II, wherein component I is fludioxonil and wherein component II is selected from azoxystrobin, picoxystrobin or kresoxim-methyl.

2. A composition according to claim 1, wherein component II is picoxystrobin.

3. A composition according to claim 1, wherein component II is kresoxim-methyl.

4. A composition according to claim 1, wherein component II is azoxystrobin.

5. A composition according to claim 1, wherein the ratio by weight of I:II is 5:1 to 1:30.

6. A composition according to claim 1, wherein the ratio by weight of I:II is selected from 2.5:1, 1.25:1 or 1:6.

7. A method of protecting plants against plant diseases by treating the plant propagation material with synergistically effective amounts consisting essentially of components I and II, wherein component I is fludioxonil and wherein component II is selected from azoxystrobin, picoxystrobin or kresoxim-methyl, in any desired sequence or simultaneously.

8. A method according to claim 7, wherein the plant propagation material is seed.

9. A method according to claim 8, wherein the seed is seed of cotton, corn, soybeans, rice or peanuts.

10. Plant propagation material which has been treated with the composition according to claim 1.

11. An agrochemical composition consisting essentially of a synergistically effective amount of at least active ingredient components I and II, wherein component I is fludionoxil and wherein component II is azoxystrobin and wherein the ratio by weight of I:II is 5:1 to 1:30.

12. A composition according to claim 11, wherein the ratio by weight of I:II is selected from 2.5:1, 1.25:1, or 1:6.
